(19) United States
(12) Patent Application Publication
(10) Pub. No.: US 2026/0120132 A1
(43) Pub. Date: Apr. 30, 2026

(54) METHODS AND SYSTEMS FOR USING CALL DATA TO IDENTIFY INFLUENTIAL FORMER NETWORK SUBSCRIBERS

(71) Applicant: T-Mobile USA, Inc., Bellevue, WA (US)

(72) Inventors: Yousef Alabssi, Parsippany, NJ (US); Belkacem Mouffok, North Brunswick, NJ (US)

(21) Appl. No.: 18/931,367

(22) Filed: Oct. 30, 2024

(51) Int. Cl. G06Q 30/0202; H04M 3/22; H04W 24/08

(52) U.S. Cl. CPC G06Q 30/0202; H04M 3/2218; H04W 24/08

(57) ABSTRACT

The present invention relates to methods and systems for identifying influential former subscribers to a network. They include constructing a graph, comprising nodes and edges, modeled on call data. The call data includes attributes of former subscribers associated with the call data. The methods and systems also include identifying an influential former subscriber based on the nodes and edges.

### BACKGROUND

Telecommunications involves the transmission of information over distances using electronic systems, such as telephones, radios, televisions, and the internet. It enables voice, data, and video communication, connecting people and businesses worldwide. One of the latest advancements in telecommunications is 5G, the fifth generation of mobile network technology. As 5G networks offer significantly higher speeds, lower latency, and greater connectivity compared to previous generations, they enable a wider range of services and applications, such as the Internet of Things (IoT), smart cities, and advanced mobile broadband.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates components of a system for identifying influential former subscribers to a network from a graph based on call data from the network.

FIG. 4 is a block diagram that illustrates an example visualization layer.

FIG. 5 is a block diagram that illustrates a detail view of a graph based on call data.

FIG. 6 is a flow chart that illustrates a method for identifying influential former network subscribers from a graph constructed from call data.

FIG. 7 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to methods and systems for identifying influential former network subscribers using call data. To illustrate this technology, one potential implementation includes a method for building a model (e.g., a network, or a graph) to assist with identifying influential former members of a telecommunications network. In this illustration, call data from the former subscribers of the network can be used to construct a graph. The graph can consist of these subscribers who have left the network and their connections with other former members. The graph can be used to determine the influence of these former members by evaluating the connections, or attributes of the connections, between them and other former members modeled by the graph. Such a method can then include ranking the former members of the graph according to influence, and identifying a most influential former member as the former member with the highest rank.

The disclosed technology can be used to reduce churn within a network. “Churn” refers to the number of customers or subscribers who decide to stop interacting with a business (e.g., canceling a subscription, or failing to renew a contract). Traditional churn management methods are inadequate for reducing churn within a telecommunications network as they do not include the relevant data (e.g., call data). Additionally, in traditional churn reduction methods, the customer is viewed as a single entity, whereas in reality each customer belongs to a network of other customers, with whom they have relationships, which influences them, and whom they influence in turn. Some of these customers are more influential than others, but traditional methods overlook the significant influence of these social network influencers. Implementations of the disclosed technology can address these problems, and others, by creating graphs based on call data, and by identifying such influencers using methods that include analyzing the structure of the graph itself.

Several challenges must be overcome in order to implement the disclosed technology. First and foremost are security considerations governing data associated with subscribers, or with the network itself. To address these security concerns, implementations of the disclosed technology include an encryption step, in which the call data used to assemble the graph is disassociated of any potentially source-identifying characteristics, and hashed to protect any sensitive, or confidential, data from cyberattack, or from unauthorized use or access.

Another challenge to implementing various designs of the technology disclosed herein is the relative cost of constructing and analyzing the graph. The cost can be measured in terms of computational time and resources (e.g., bytes of RAM or storage, cycles of the CPU or GPU, network bandwidth, or Watts of power consumed). For example, in a sufficiently large telecommunications network, creating a graph of only those subscribers who leave the network within a given time period (e.g., a week) can lead to building a graph that comprises hundreds of thousands of nodes, all of which can be interconnected by dozens of edges, and each edge in itself can comprise a call history that includes dozens of distinct call records. Implementations of the disclosed technology address this problem, and others, with implementing graph solutions to network churn by including steps to reduce an overall size of the graph, while preserving essential information.

In some implementations, methods for identifying influential former subscribers include determining an appropriate intervention to regain or retain that influencer. For example, interventions can include marketing campaigns, sales calls, or technical support. The disclosed technology can enable sales teams to refine their processes by identifying areas with high churn rates and understanding the reasons behind them. It can also assist domain experts with making informed decisions about network investments, such as building infrastructure in areas with high influencer-driven churn.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

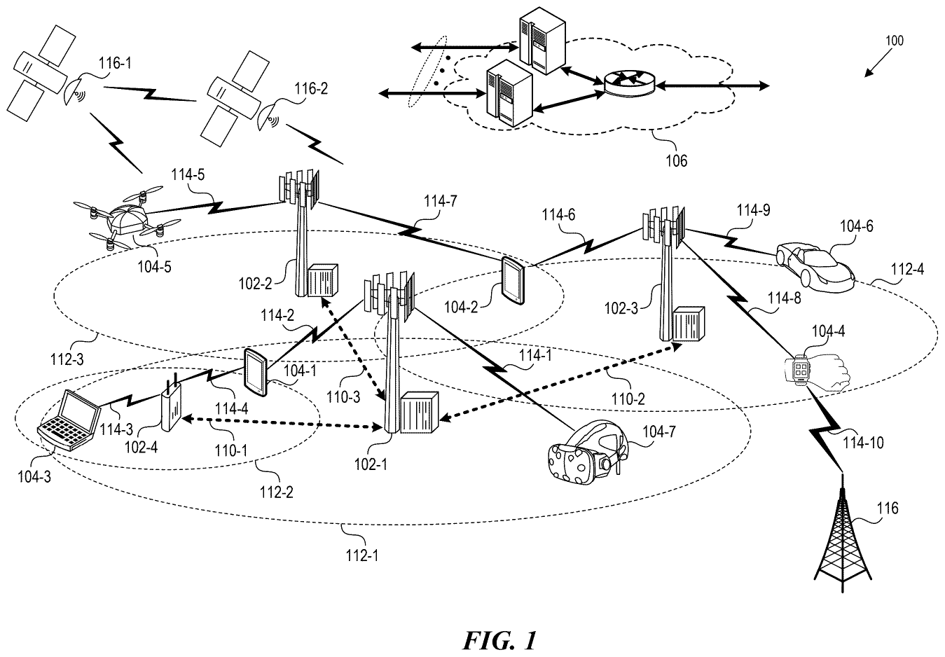

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

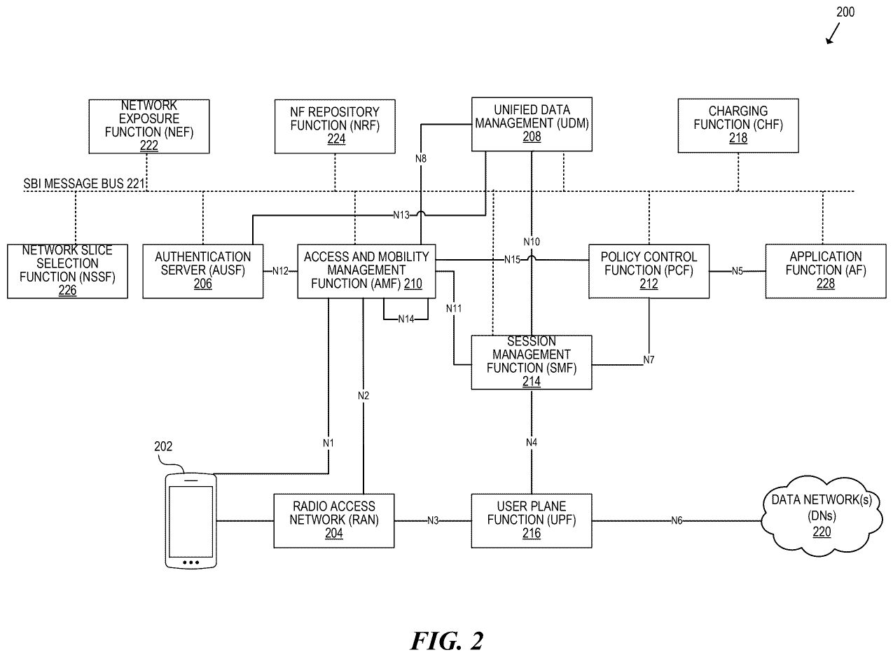

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNS) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Identifying Influential Former Network Subscribers Using Call Data

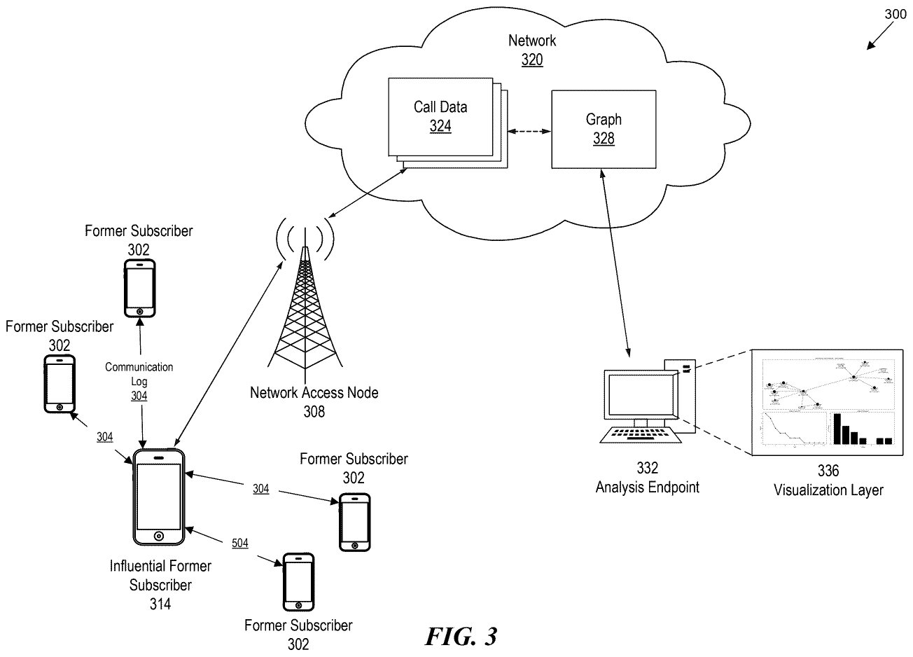

FIG. 3 is a block diagram that illustrates components of a system 300 for identifying an influential former subscriber 314 to a network 320 (e.g., a telecommunications network). To identify the influential former subscriber 314, the system 300 constructs a graph 328 based on call data 324 (e.g., data generated from voice calls, video calls, SMS messages, RCS messages, text messages, voice messages, video messages, emails, or other communications). Call data 324 can include the phone number or of the person making the communication, the phone number of the person receiving the communication, the date and time when the communication occurred or started, the date and time when the communication ended, the length of the communication, the identity of the originating and terminating callers, the type of communication (e.g., local, long-distance, international), information on whether the communication was completed, failed, or busy, and details related to the cost of the communication.

Call data 324 can be communicated via core network elements and the radio network 218, which can include a network access node (NAN) 308. The NAN 308 can comprise multiple NAN, as well as one or more satellites. Examples of the NANs can include a macro cell, a small cell, a micro cell, a femto cell, or a pico cell. The NAN 308 can include multiple NANs of varied type and service area.

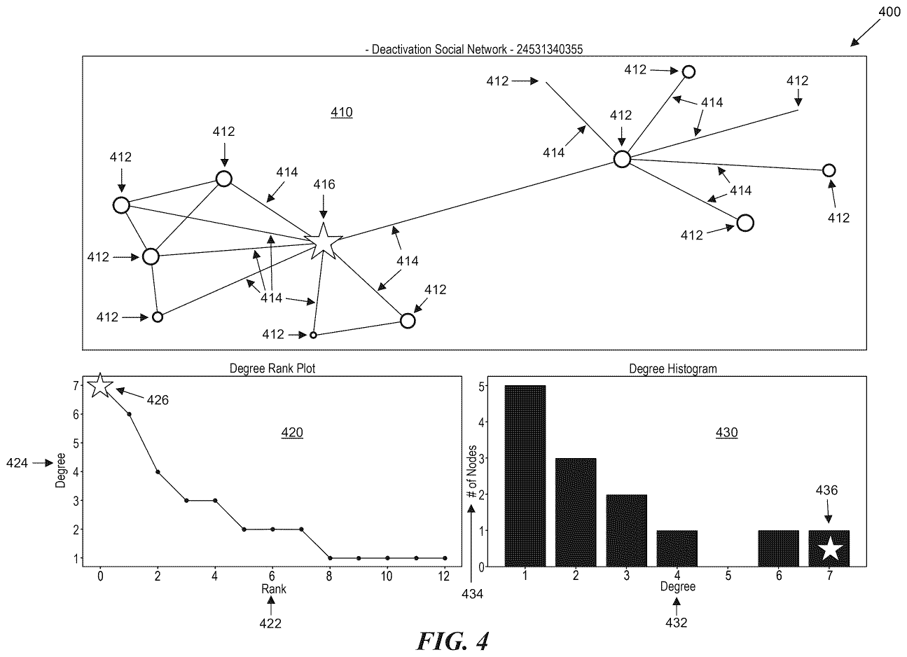

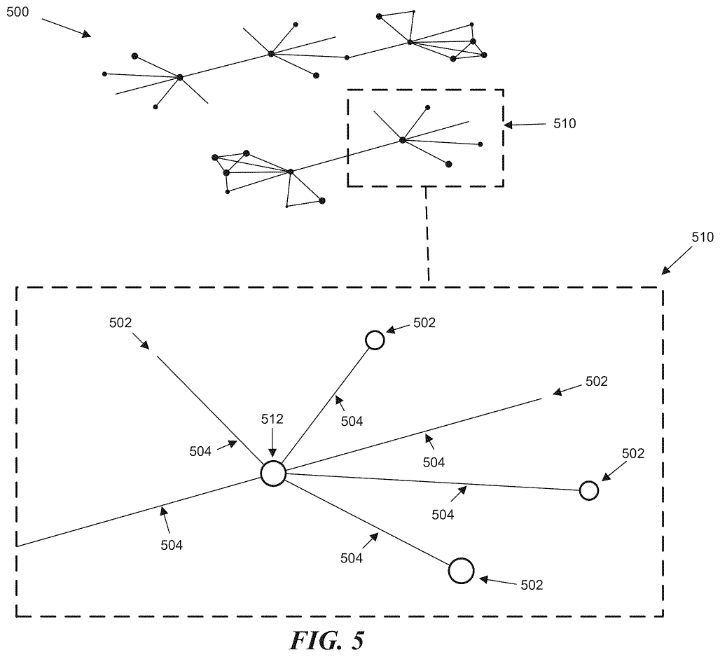

The graph 328 includes nodes connected by edges that are modeled on attributes of former subscribers 302 and the call data 324, and will be illustrated in greater detail in FIGS. 4 and 5. In some implementations, the call data 324 is generated by associating former subscribers 302 with communication logs 304, or call detail records, to create a former subscriber communication log. The former subscribers 302 can be extracted from a churn list. The churn list can include subscribers who left the telecommunications network 320 within a specified time window. In some implementations, the former subscribers 302 are subscribers who left the network 320 during a specified time window. The former subscribers 302 can include current subscribers who are still part of the network 320. The influential former subscriber 314 can be an influential subscriber who currently subscribes to the network 320.

The call data 324 can include communications made between former subscribers 302 of the network, as well as communications in which the former subscribers 302 were solely the progenitors or recipients of the communications, and the communications were generated or received by subscribers still currently subscribed to the network 320 after the specified time window, or subscribers who were subscribed to an entirely different network when the communication was made. In some implementations, the system 300 associates the former subscribers 302 with the communication logs 304 based on an identifier. The churn list can include such identifiers. For example, the identifier can include a country code, a network code, and/or a subscriber identification number that, when combined, form a unique number (e.g., an International Mobile Subscriber Identity (IMSI)) that enables the system 300 to not only identify, but also authenticate and bill the former subscribers 302.

In some implementations, the call data 324 is based on an encrypted log. The encrypted log can be generated by encrypting the former subscriber communication log, or the communication logs 304. The encrypted log can include identity ciphers and session metrics of communications made by the former subscribers 302, or between the former subscribers 302. In some implementations, the encrypted log includes subscription durations for the former subscribers 302. The session metrics can include cumulative lengths of calls and total numbers of calls between pairs of former subscribers 302.

Next, the system 300 uses properties of the graph 328 that represent real-life attributes of the network 320 to identify the influential former subscriber 314. In some implementations, the system 300 refers to a pre-built graph which was generated using a separate system, or with alternative data, or at a different time. The system 300 can construct a graph 328 from the encrypted log. In some implementations, the graph 328 is of former subscribers 302, or a former subscriber graph.

Identifying the influential former subscriber 314 can be facilitated by the system 300, which can port the graph 328 to an analysis endpoint 332 for reference by a user (e.g., a domain expert on a sales, marketing, engineering, or analytics team). The system 300 can render a visualization layer 336 for the benefit of the user. The visualization layer 336 can include a first representation of the graph 328, and a second representation of the influential former subscriber 314 within the first representation, along with any other pertinent graph properties and network attributes. The visualization layer 336 will be illustrated in greater detail in FIG. 4.

FIG. 4 is a block diagram that illustrates an example visualization layer 400. The visualization layer can include a graph representation 410 configured to illustrate the graph 328 of FIG. 3. The graph representation 410 includes nodes 412 and edges 414. The edges 414 connect the nodes 412. A node 412 can be connected to one or more other nodes 412 in the graph representation 410. The graph representation 410 can be generated at the analysis endpoint 332, or generated remotely and accessible as a cloud service using the analysis endpoint 332.

In some implementations, constructing the graph includes assigning priorities to the nodes 412 based on attributes of the former subscribers. An example attribute of the former subscribers which can be used to assign priorities to the nodes 412 is subscription duration (e.g., “tenure”), or customer lifetime value (CLV). For example, a former subscriber who was subscribed to the telecommunications network for a longer duration can be represented by a node with a higher priority. In the visualization layer 400, the graph representation 410 can represent nodes based on priority. For example, a node 412 with a higher priority can be displayed as larger than a node 412 with a lower priority. Additionally, the graph representation 410 can also portray destination carriers of former subscribers. For example, a node 412 representing a first former subscriber who left to join a first competing network can be illustrated using a first color, while a node 412 representing a second former subscriber who left to join a second competing network can be illustrated using a second color. Other methods of visually distinguishing nodes based on destination carrier can be used in alternative implementations.

In some implementations, constructing the graph includes assigning weights to the edges 414 based on call data. An example call data feature which can be used to assign weight to the edges 414 includes the cumulative lengths of calls, and/or the total number of calls. For example, a pair of former subscribers who spoke for a longer cumulative time over a greater number of calls can be connected by an edge 414 with a greater weight. In the visualization layer 400, the graph representation 410 can represent the edges 414 based on weight. For example, an edge 414 with greater weight can be displayed as a thicker line than an edge 414 with less weight. Other methods of visually distinguishing nodes based on destination carrier can be used in alternative implementations.

Using the visualization layer 400, an influential former subscriber can be identified based on properties of the graph, for example, by determining a prominent node 416 within the graph representation 410. Identification can be a feature which is automatically applied by the visualization layer 400, or selected by the user via an input. Additionally, determining the prominent node 416 can be assisted by histograms and plot included by the visualization layer 400, illustrated in FIG. 4 as a first plot 420 and a second plot 430. The first plot 420 can include a first 422 axis and a second axis 424 for presenting an alternate view of the graph properties (e.g., degree versus rank) and displaying a second prominent node 426, while the second plot 430 can present a separate view of the graph properties using a third axis 432 and a fourth axis (e.g., degree versus number of nodes) to display a third prominent node 436. The second prominent node 426 and third prominent node 436 can be associated with the same influential former subscriber, or they can indicate different influential former subscribers. They can also agree or disagree with the prominent node 416 indicated in the graph representation 410.

Within the visualization layer, a recommendation can also be generated for display. The recommendation can include a predicted intervention, or an effective intervention, for the influential former subscriber associated with the prominent node 416. The recommendation can be based on attributes of the influential former subscriber, as well as features of the call data associated with the influential former subscriber.

In some implementations, the graph representation 410 is based on a subgraph of the graph. The subgraph can be selected by a user using a call data query language. The call data query language can be based on the communication attributes of the call data, which can include encrypted communications, as well as the subscriber attributes of the former subscribers. Some implementations can include building the call data query language.

For example, the visualization layer 400 can be configured to receive a call data query from the user. The call data query can include communication attributes and subscriber attributes which the user has selected, and the graph can be divided into a list of subgraphs based on at least one of an upper size limit based on nodes 412, or a minimum number of edges 414. The chosen subgraph can be selected from the list of subgraphs based on at least one of the selected communication attributes, or the selected subscriber attributes.

An example of a subgraph 510 being selected from a graph 500 that is based on call data is illustrated in FIG. 5. For example, the graph 500 can include isolated clusters, and each cluster can represent a distinct subgroup of the former subscribers to the network. The subgraph 510 can be based on a cluster, which can be defined according to a key session metric. In some implementations, the key session metric includes properties of the graph (e.g., a graph “island”), or properties selected by a user (e.g., a key performance indicator (KPI)). An example property is a network experience score. The network experience score can be included as part of the call data and can include one or more of the following: a coverage of a subscriber, a drop rate for a specified time window, a number of access failures, a number of data drops, and a latency (e.g., while browsing web pages).

The key session metric can be used to ascertain a significant former subscriber community from the isolated clusters. For example, the key session metric can be used to rank, or reorganize, the isolated clusters of the graph into a ranked list. A cutoff score can be applied to form an abbreviated list from the ranked list, where the cutoff score is based on the key session metric. In some implementations, where a user wishes to see only those subgraphs with low network experience scores rendered on the visualization layer, they can select network experience score as the key session metric, and then set a cutoff to exclude all subgraphs that include former subscribers with network experiences scores above the cutoff. The significant former subscriber community can then be selected based on a superior rank in the abbreviated list, which can then become the basis for the subgraph 510.

The subgraph 510 includes nodes 502, edges 504, and a high-ranking node 512. The nodes 502 can represent individual former subscribers, while the edges 504 can represent the session metrics of voice calls made between the individual former subscribers. A single edge can include a history of communications made between two former subscribers who, as represented in the subgraph 510, are connected by the single edge. The high-ranking node 512 can be modeled on a subscriber to the network, either former or a current. The subscriber modeled by the high-ranking node 512 can have an outsize social influence on their fellow subscribers.

Some implementations can identify the high-ranking node 512 by counting the number of neighbors that each node 502 has in the subgraph 510, ranking the nodes 502 such that the node 502 with the most neighbors has the highest ranking, and then selecting that node to be the high-ranking node 512 (e.g., based on the assumption that the former subscriber who had communication histories with the greatest number of other former subscribers, was the most influential).

To illustrate, in some examples the high-ranking node 512 is identified from a ranking of the nodes 502. The ranking can be constructed using various methods. The ranking can be made using the graph 500, or the subgraph 510. The ranking can be based on neighbor nodes that are proximate to the node 502. To be deemed “proximate” to a node 502, a neighbor node can fall within a certain distance (e.g., a number of “hops,” or intervening edges, between the neighbor node and the node). The certain distance can be determined by a model trained on a distribution based on properties of the graph 500 or subgraph 510, or the certain distance can be set by the user. Neighbor nodes can also be called proximate nodes. In some implementations, the high-ranking node 512 is analyzed to determine a set of outgoing edges that connect the high-ranking node to its proximate nodes. An influential former subscriber can be identified from a group of former subscribers by finding a prominent node in the graph, where prominence is measured according to “degree,” or the number of edges connecting that node to other nodes within its community (e.g., an “island” in the graph, or a significant former subscriber community within the network).

Other methods for defining “influence,” and then selecting for properties within the graph that correspond to such definitions, are contemplated by this disclosed technology. In some implementations, influence is a function of the number of connections a former member has with other former members. Influence can also be measured according to a weight that is applied to the graph, which scores some connections as more influential than others. For example, connections with a Primary Account Holder, or connections with a Corporate Account Holder, can be weighed more. The weight can be calculated according to the call data, or according to properties of the graph 500. For example, an edge can be weighed according to the number of dependents on the account, or connections with a Corporate Account Holder and secondary users.

Influence can also be measured according to priority, which can include rankings applied to the nodes 502 based on attributes of the subscribers modeled by the nodes 502. For example, in a subgraph 510 that represents an organization, the nodes 502 can include an organizational hierarchy (e.g., a title, or position within a company) that is not accurately modeled according to the properties of the graph. To illustrate, a corporate director can have relatively few direct connections, and thus appear less influential, while a subordinate to the corporate director-who is tasked with maintaining the contacts of the corporate director—can appear to have an outsize influence, when in fact they are serving as a proxy for the corporate director. In such instances, the organization can be isolated from the graph 500 as a subgraph 510 by using “organizational membership” as a key session metric, and then the nodes 502 can be prioritized according to “title” within the organization.

Attributes from the high-ranking node 512 can be used to predict an intervention. For example, the high-ranking node 512 can be modeled on a former or current subscriber, and the call data for the subscriber can be assessed by analyzing the outgoing, and/or incoming, edges of the high-ranking node 512, as well as relevant subscriber attributes modeled by peripheral nodes. The peripheral nodes can be restricted to only include the neighbor nodes of the high-ranking node 512, or expanded until they encompass the entire subgraph 510. A critical session metric can be determined from the high-ranking node 512 by analyzing its attributes, and/or the communication attributes modeled by the edges that connect the prominent node to peripheral nodes. The high-ranking node 512 can also be referred to as a prominent node. One attribute for the high-ranking node 512 can be network experience score.

An effective intervention can be predicted for the prominent node based on the critical session metric. For example, if the network experience score for the high-ranking node 512 is low, an appropriate intervention can be devoting additional network resources to the high-ranking node 512, or prompting the user to make calls or offers to the subscriber modeled by the high-ranking node 512. The calls or offers can detail improvements to the service (e.g., where poor service is assumed to be a cause for the high-ranking node 512 departing the network).

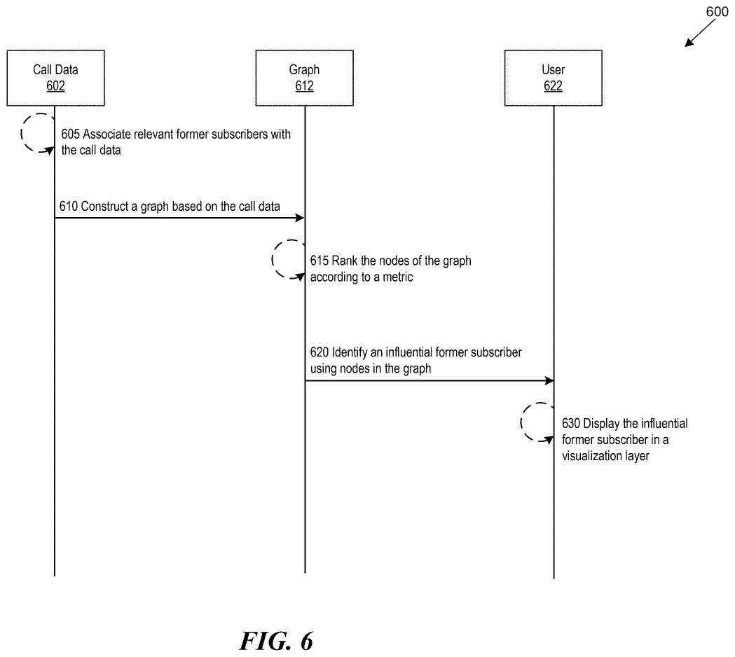

FIG. 6 is a flow chart that illustrates a method 600 for identifying influential former network subscribers from a graph constructed from call data. In some implementations, the method 600 includes a method for reducing churn in a telecommunications network. The method 600 includes call data 602. The call data 602 can be included in component 605, where the call data 602 is associated the relevant former subscribers. The method 600 includes component 610, where a graph 612 is constructed based on the call data 602. The graph 612 can include nodes and edges based on the relevant former subscribers associated with the call data 602. The method 600 can include component 615, where the graph 612 ranks the nodes according to a metric (e.g., degree). The method 600 includes component 620, in which the graph 612 identifies an influential former subscriber to a user 622 using the nodes. For example, after ranking the nodes according to degree, the graph 612 can identify a node with the greatest number of edges as the influential former subscriber. The method 600 can include a component 630 in which the influential former subscriber is displayed in a visualization layer. The visualization layer can include a representation of the graph 612, as well as key attributes of the call data 602, to facilitate further analysis by the user 622.

In some implementations, the disclosed technology involves social network analysis of subscribers to a telecommunications network. The subscribers can comprise current and/or former subscribers to the telecommunications network. Social network analysis can include the process of investigating social structures through the use of networks (e.g., graphs in which nodes and/or edges comprise attributes) and graph theory (e.g., underlying principles defining mathematical structures in which relationships between entities are modeled as edges connecting nodes), wherein relationships between the formers subscribers are modeled as edges.

Graphs, however, can be unwieldy to use for analysis, due to their size, as well as the computational costs of performing basic calculations with them. Implementations of the disclosed technology can include steps to reduce an overall size of the graph, while preserving essential information. For example, these steps can include at least one of sparsification, spanners, decomposition, aggregation, or sampling.

Such steps can include reducing the number of edges in the graph while preserving its essential properties, such as connectivity or distances between nodes. Steps to reduce the overall size of the graph can include randomly selecting a subset of edges to retain, ensuring that the resulting graph maintains key properties. The methods and systems disclosed herein can include subgraphs that approximate the distances between nodes within a certain factor. They can also include techniques from spectral graph theory to retain edges that preserve the graph's spectral properties. Additionally, they can include graph compression techniques aimed to reduce the storage size of the graph by exploiting patterns and redundancies in its structure. For example, the systems disclosed herein can use adjacency list compression, where run-length encoding or gap encoding can be used to compress adjacency list data structures. Furthermore, graph rewriting can be used to replace common substructures with single nodes or simpler structures. Other methods can include graph coarsening, where the methods include merging nodes and edges to create smaller, coarser versions of the graph, as well as decomposition, where the graph is broken down into smaller, more manageable subgraphs that can be processed independently.

Other techniques which can be included in the methods and systems disclosed herein, for similar or related purposes, include tree decomposition, path decomposition, graph partitioning, and graph aggregation. Multiple nodes can be combined into single supernodes, based on attributes or connectivity, while multiple edges can be combined into a single superedges based on attributes or connectivity. Communities can also be identified and aggregated based on clusters within the graph. The graph can also be sampled to create smaller samples of the graph, which still retain the essential properties of the original graph, using techniques such as node sampling, edge sampling, and/or subgraph sampling.

### Computer System

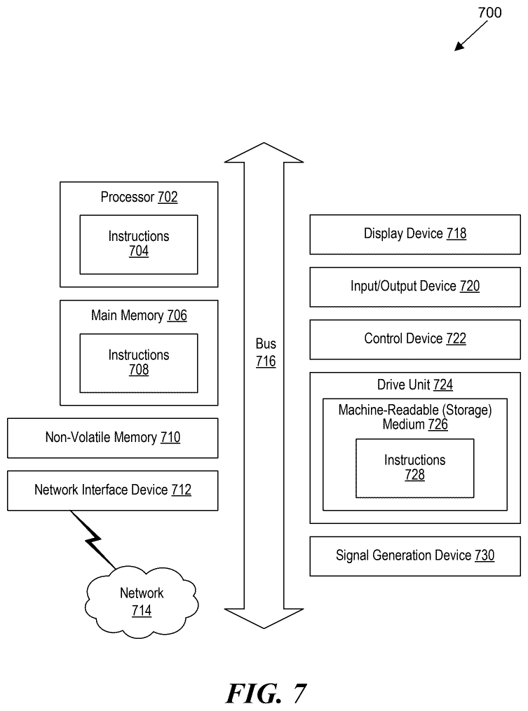

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementations, the computer system 700 can be an embedded computer system, a system-on-chip (SOC), a single-board computer system (SBC), or a distributed system such as a mesh of computer systems, or it can include one or more cloud components in one or more networks. Where appropriate, one or more computer systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A method for reducing churn in a telecommunications network by identifying influential former subscribers using call detail records, the method comprising:
extracting data indicative of former subscribers from a churn list corresponding to subscribers who left the telecommunications network within a specified time window;
associating the former subscribers with the call detail records of voice calls made by the former subscribers during the specified time window to form a former subscriber communication log;
encrypting the former subscriber communication log to form an encrypted log comprising identity ciphers and session metrics of the voice calls;
constructing a former subscriber graph from the encrypted log, the former subscriber graph including:
isolated clusters, each cluster representing a distinct subgroup of the former subscribers;
nodes within the isolated clusters representing individual former subscribers; and
edges between pairs of the nodes representing the session metrics of the voice calls;
ascertaining a significant former subscriber community from the isolated clusters based on a key session metric;
identifying an influential former subscriber by finding a prominent node with a greatest number of edges connecting it to other nodes in the significant former subscriber community; and
rendering the influential former subscriber and the significant former subscriber community in a visualization layer for a user.

2. The method of claim 1, wherein the encrypted log includes subscription durations for the former subscribers, wherein the session metrics include cumulative lengths of calls and total numbers of calls between pairs of former subscribers, and wherein constructing the former subscriber graph from the encrypted log further comprises:
assigning priorities to nodes based on the subscription durations,
wherein a former subscriber who was subscribed to the telecommunications network for a longer duration is represented by a node with a higher priority; and
designating weights to edges based on the cumulative lengths of calls combined with the total numbers of calls,
wherein a pair of former subscribers who spoke for a longer cumulative time over a greater number of calls are connected by an edge with a greater weight.

3. The method of claim 2, wherein rendering the influential former subscriber and the significant former subscriber community in a visualization layer further comprises:
representing nodes based on priority, such that the node with the higher priority is displayed as larger than a node with a lower priority;
representing edges based on weight, such that the edge with the greater weight is displayed as a first color and an edge with a smaller weight is displayed as a second color; and
assigning colors to the nodes based on destination carriers that former subscribers switched to after leaving the telecommunications network.

4. The method of claim 1, further comprising:
analyzing the prominent node to determine a critical session metric of the session metrics of the voice calls represented by the edges connecting the prominent node to peripheral nodes in the significant former subscriber community;
predicting an effective intervention for the prominent node based on the critical session metric; and
recommending a predicted intervention for the influential former subscriber in the visualization layer.

5. The method of claim 1, wherein the key session metric is an input provided by the user, and wherein ascertaining the significant former subscriber community further comprises:
building a former subscriber query language to reorganize the former subscriber graph according to selected key session metrics;
receiving the input with a selected key session metric sent by the user;
ranking the isolated clusters as an abbreviated list based on the selected key session metric; and
selecting the significant former subscriber community based on a superior rank in the abbreviated list.

6. The method of claim 1, wherein the session metrics include a network experience score, comprising at least one of:
a coverage for a former subscriber,
a drop rate for the specified time window,
a number of access failures,
a number of data drops, or
a latency while browsing web pages.

7. A non-transitory, computer-readable storage medium comprising instructions recorded thereon, wherein the instructions when executed by at least one data processor of a system, cause the system to:
encrypt a log of communications made by subscribers before they left a network;
construct a graph based on encrypted communications between former subscribers, the graph including:
clusters comprising nodes connected by edges,
wherein the nodes are modeled on subscriber attributes of the former subscribers, and
wherein the edges are modeled on communication attributes of the encrypted communications;
rank the nodes within the graph based on a set of neighbor nodes connected to each node; and
identify an influential former subscriber by analyzing a position of the influential former subscriber within a node ranking.

8. The non-transitory, computer-readable storage medium of claim 7, wherein the encrypted communications includes tenures of former subscribers, wherein the communication attributes include cumulative lengths of calls and total numbers of calls, and wherein constructing the graph causes the system to:
assign priorities to nodes based on the tenures of the former subscribers,
wherein a former subscriber having a longer tenure is represented by a node with a greater priority; and
designate weights to edges based on the cumulative lengths of calls combined with the total numbers of calls,
wherein a pair of former subscribers who spoke for a longer cumulative time over a greater number of calls are connected by an edge with a greater weight.

9. The non-transitory, computer-readable storage medium of claim 8, wherein identifying the influential former subscriber further causes the system to:
render the influential former subscriber in a visualization layer;
display the nodes according to the priorities;
display the edges according to the weights; and
assign colors to the nodes based on destination carriers that the former subscribers switched to after leaving the network.

10. The non-transitory, computer-readable storage medium of claim 7, wherein identifying the influential former subscriber further causes the system to:
analyze a prominent node modeled on the influential former subscriber to determine a critical session metric from the communication attributes modeled by the edges that connect the prominent node to peripheral nodes;
predict an effective intervention for the influential former subscriber based on the critical session metric; and
recommend the effective intervention for the influential former subscriber at an analysis endpoint.

11. The non-transitory, computer-readable storage medium of claim 7, wherein the graph comprises a chosen subgraph selected by a user using a call data query language, and wherein constructing the graph further causes the system to:
build the call data query language according to the communication attributes of the encrypted communications, as well as the subscriber attributes of the former subscribers.

12. The non-transitory, computer-readable storage medium of claim 11, wherein building the call data query language further causes the system to:
receive a call data query from the user comprising selected communication attributes and selected subscriber attributes;
divide the graph into a list of subgraphs based on at least one of:
an upper size limit, or
a minimum number of edges; and
select the chosen subgraph from the list of subgraphs based on at least one of:
the selected communication attributes, or
the selected subscriber attributes.

13. The non-transitory, computer-readable storage medium of claim 7, wherein the communication attributes include a network experience score, the network experience score comprising at least one of:
a coverage for a former subscriber,
a drop rate,
a number of access failures,
a number of data drops, or
a latency while browsing web pages.

14. A system comprising:
at least one hardware processor; and
at least one non-transitory memory storing instructions, which, when executed by the at least one hardware processor, cause the system to:
construct a graph comprising:
nodes modeled on subscriber attributes; and
edges modeled on call data; and
identify a former subscriber from a ranking of the nodes made using the graph,
wherein the ranking is based on neighbor nodes that are proximate to each node.

15. The system of claim 14, wherein the subscriber attributes include customer lifetime values, wherein the call data include cumulative lengths of calls and total numbers of calls, and wherein constructing the graph further causes the system to:
assign priorities to the nodes based on the customer lifetime values; and
designate weights to the edges based on the cumulative lengths of calls combined with the total numbers of calls.

16. The system of claim 15, wherein identifying the former subscriber further causes the system to:
render the former subscriber in a visualization layer;
display the nodes based on the priorities; and
display the edges based on the weights.

17. The system of claim 14, further causing the system to:
analyze a node modeled on the former subscriber to determine a set of outgoing edges connecting the node to peripheral nodes;
predict an intervention for the former subscriber based on at least one of:
relevant call data modeled by the set of outgoing edges, or
relevant subscriber attributes modeled by the peripheral nodes; and
generate for display a recommendation based on the intervention predicted.

18. The system of claim 14, wherein the graph comprises a chosen subgraph selected by a user using a query language, and wherein constructing the graph further causes the system to:
build the query language according to the call data, as well as the subscriber attributes.

19. The system of claim 18, wherein building the query language further causes the system to:
receive a call data query from the user comprising selected call data and selected subscriber attributes;
divide the graph into a list of subgraphs based on at least one of:
an upper subscriber limit, or
a minimum number of edges; and
select the chosen subgraph from the list of subgraphs based on at least one of:
the selected call data, or
the selected subscriber attributes.

20. The system of claim 14, wherein the call data include a network experience score, comprising at least one of:
a coverage of a subscriber,
a drop rate for a specified time window,
a number of access failures,
a number of data drops, or
a latency.
